(19) United States
(12) Patent Application Publication
(10) Pub. No.: US 2026/0296724 A1
(43) Pub. Date: Oct. 1, 2026

(54) COMPOSITE PALLET FOR USE IN THE TRANSPORT SECTOR

(71) Applicant: TELATEKS TEKSTIL ÜRÜNLERI SANAYI VE TICARET ANONIM SIRKETI, Tuzla, Istanbul (TR)

(72) Inventors: Ergenç INELER, Manisa (TR); Furkan TOZAKLI, Manisa (TR); Çagatay BASDOGAN, Manisa (TR)

(21) Appl. No.: 19/490,153

(22) PCT Filed: May 29, 2024
(86) PCT No.: PCT/TR2024/050556

§ 371 Date: Dec. 4, 2025

(30) Foreign Application Priority Data
Jun. 16, 2023 (TR) 2023/007108

(51) Int. Cl. B65D 19/00

(52) U.S. Cl. CPC B65D 19/0095; B65D 2519/00034; B65D 2519/00044; B65D 2519/00069; B65D 2519/00079; B65D 2519/00273; B65D 2519/00323; B65D 2519/00333

(57) ABSTRACT

The invention relates to a pallet structure comprising composite profiles produced by pultrusion production method for use in the transport sector. By pultrusion method, composite profiles are formed from one or more fibres and/or fabrics selected from the group containing glass, carbon, aramid, basalt, polyester at least 60% by weight and one or more resins selected from the group containing polyester, vinyl ester, epoxy, phenolic, polyurethane. The composite pallet is assembled with these profiles. The composite pallet can be used for stocking and logistics activities.

### TECHNICAL FIELD

The invention relates to a pallet structure comprise composite profiles produced by pultrusion production method for use in the transport sector.

### KNOWN STATE OF THE ART

As one of the elements of the transport sector, pallet is the transport equipment that allows the products placed on it to be transported easily and without wearing out. In the transport sector, pallet production is made using materials such as wood, plastic and steel.

For example, in the patent application numbered TR2017/15442, the pallet, which is the most important part of the outer packaging, prepared from metal composition in order to easily transport the packaged products by forklift or pallet jack, is disclosed.

In the patent application numbered TR2018/02316 describes a durable wood composite pallet composition used in pool sides, garden materials, scaffolds, packages, export or import goods.

However, pallets produced using wooden material are not resistant to water and chemicals. After a certain number of uses, it becomes deformed and becomes unusable, so there is difficulty in transporting the material on it and it can damage the transported material. Wooden pallets need to be heat treated to prevent bacteria. Although plastic pallets are lighter than wooden pallets, their mechanical strength is lower than wooden pallets. Metals are mechanically much stronger and longer lasting than other pallets, but they create difficulties in terms of use due to their heavy weight.

As a result, due to the above-mentioned disadvantages and the inadequacy of the existing solutions, a development in the relevant technical field has become necessary.

### OBJECT OF THE INVENTION

The invention is inspired by the present invention and aims to solve the above-mentioned problems.

The main object of the invention is to provide a composite pallet structure for use in the transport sector.

An object of the invention is to provide a high strength composite pallet structure which is resistant to deformation despite its light structure.

An object of the invention is to provide a composite pallet structure resistant to water and chemicals.

An object of the invention is to provide a cost-effective pallet structure by means of pultrusion production method.

In order to fulfil the above-mentioned objects, the invention is a pallet for use in the transport sector, characterized by comprising, composite profiles comprising one or more resins selected from the group consisting of polyester, vinyl ester, epoxy, phenolic, polyurethane reinforced with one or more fibres and/or fabrics selected from the group consisting of glass, carbon, aramid, basalt, polyester.

According to an embodiment of the invention, the pallet comprises composite profiles comprising one or more resins selected from the group consisting of polyester, vinyl ester, epoxy, phenolic, polyurethane reinforced with one or more fibres and/or fabrics selected from the group consisting of at least 60% by weight of glass, carbon, aramid, basalt, polyester.

According to one embodiment of the invention, the pallet comprises composite profiles comprising polyester resin reinforced with at least 60% by weight of glass fibres and/or fabrics.

According to one embodiment of the invention, the pallet comprises composite profiles comprising polyester resin reinforced with 70% by weight of glass fibres and/or fabrics.

In embodiments of the invention, the number of profiles, profile dimensions, number of wedges and wedge dimensions used for pallet construction may vary according to the dimensions of the required pallet.

In embodiments of the invention, pultrusion, infusion, rtm and lite rtm production methods can be used for the production of the profiles.

The structural and characteristic features and all advantages of the invention will be more clearly understood by means of the figures given below and the detailed description written by making references to these figures, and therefore, the evaluation should be made by taking these figures and detailed description into consideration.

### FIGURES TO HELP UNDERSTANDING THE INVENTION

FIG. 1 is a perspective view of a 1270×800 mm Composite Pallet, an example of the invention.

FIG. 2, M6 countersunk imbus screw and fibre nut connection view between profiles.

### DESCRIPTION OF PART REFERENCES

100. Composite pallet
11. Pallet top surface wedge top short profile
12. Pallet top surface weft short profile
20. Long profile on the upper and lower surface of the wedge
30. Box profile used as wedge on pallet
40. Screw
50. Nut

### DETAILED DESCRIPTION OF THE INVENTION

In this detailed description, the preferred embodiments of the composite pallet which is the subject matter of the invention are described only for the purpose of a better understanding of the subject matter.

The invention relates to a pallet structure consisting of composite profiles produced by pultrusion production method for use in the transport sector.

Composite material is a material made of two or more component materials with significantly different physical and chemical properties and has different properties when combined. In composite pallet production, horizontal profiles and wedges forming the pallet surface are produced by reinforcing fibres and fabrics selected from at least 60% by weight glass, carbon, aramid, basalt, polyester to resins selected from polyester, vinyl ester, epoxy, phenolic, polyurethane, drawn in the 0° (zero) degree direction by pultrusion method. By means of this method, composite profiles with high mechanical values can be obtained. Pallets designed with these profiles provide high load carrying, long life, resistance to chemicals and environmental conditions.

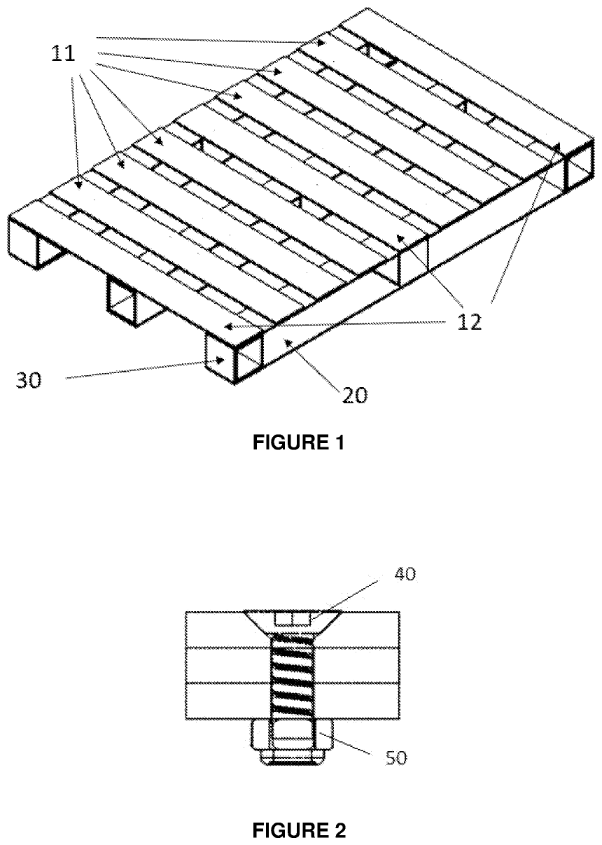

The pallet top surface chock top short profile (11) and pallet top surface weft short profile (22) parts in FIG. 1, where an example of the invention is shown, are produced by reinforcing 70% by weight glass fibre and/or fabric into polyester resin by using pultrusion method. The dimensions of this profile are 101±1 mm wide and 5±0.5 mm thick. During production, a total of 9 profiles were cut in 800 mm±10 mm length and used on the upper surface of the pallet. The number of profiles used may vary according to the size of the pallet.

The long profile on the upper and lower surface of the wedge (20) in FIG. 1 is also produced by reinforcing polyester resin with 70% by weight glass fibre and/or fabric by using pultrusion method. The dimensions of this profile are 101±1 mm wide and 5±0.5 mm thick. During production, 1270 mm±10 mm long profiles were cut and a total of 6 profiles were used on the lower and upper surfaces of the wedge. The number of profiles used may vary according to the size of the pallet.

The box profile used as wedge on pallet (30), in FIG. 1, is also produced by reinforcing polyester resin with 70% by weight glass fibre and/or fabric by using pultrusion method. The dimensions of this profile are 100×100±1 mm and 6±0.5 mm thick box profile. During production, 9 pieces were cut in 100 mm±5 mm length and used as wedges on the pallet. The number and size of wedges used may vary according to the size of the pallet.

The screws (40) and nuts (50) shown in FIG. 2 are preferably used in the assembly of the profiles produced. In order to connect the box profile used as wedge on pallet (30), the long profile on the upper and lower surface of the wedge (20) and the pallet top surface wedge top short profile (11), the screws shown in 2 are used with a 1 cm difference between them. Pallet top surface weft short profiles (22) are preferably fixed with one screw from three points.

In one example of the invention, the planks used in the composite pallet are 100 mm wide and 5 mm thick. In these plans, 6 layers of L1400 fabric (1 m²=1400 gr) were used. In resin components, polyester resin 80%+, catalyst 1%+, filler 5%+ and mould release agent 0.5%+ were used in 400-800 cp viscosity specific to pultrusion production. The test results of the produced plate are as follows.

TABLE 1
Test results of the composite pallet sample
within the scope of the invention

| Property | Test Method | Unit | Results |
|---|---|---|---|
| Density | ASTM D 792 | g/cm3 | 2 |
| Flexural Strength | ASTM D 790 | MPa | 715 |
| Flexural Modulus | ASTM D 790 | GPa | 46 |
| Flexural Strain | ASTM D 790 | % | 2 |
| Short Beam Shear | ASTM D 2344 | MPa | 31 |

1. A pallet for use in the transport sector, characterized by comprising; composite profiles consisting of one or more resins selected from the group consisting of polyester, vinylester, epoxy, phenolic, polyurethane which reinforced with one or more fibres and/or fabrics selected from the group consisting of glass, carbon, aramid, basalt, polyester.

2. The pallet according to claim 1, characterized by comprising; composite profiles consisting of one or more resins selected from the group comprise of polyester, vinyl ester, epoxy, phenolic, polyurethane which reinforced with one or more fibres and/or fabrics selected from the group consisting of glass, carbon, aramid, basalt, polyester at least 60% by weight.

3. The pallet according to claim 1, characterized by comprising; composite profiles consisting of polyester resin reinforced with at least 60% by weight glass fibres and/or fabrics.

4. The pallet according to claim 3, characterized by comprising; composite profiles consisting of polyester resin reinforced with 70% by weight glass fibres and/or fabrics.

5. The pallet according to any one of the preceding claims, characterized by comprising; composite profiles produced in predetermined sizes, shapes and numbers by pultrusion, infusion, rtm or lite rtm methods.
